(19) United States
(12) Patent Application Publication
(10) Pub. No.: US 2010/0106414 A1
(43) Pub. Date: Apr. 29, 2010

(54) METHOD OF PERFORMING ROUTING WITH ARTIFICIAL INTELLIGENCE

(76) Inventor: John Whitehead, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/258,454

(22) Filed: Oct. 27, 2008

(51) Int. Cl. G01C 21/00

(52) U.S. Cl. 701/213

(57) ABSTRACT

A method of performing routing in a global navigation satellite system (GNSS) navigation device incorporates user preferences determined through driving habits of the user. The GNSS navigation device stores a driving history, namely a plurality of route segments corresponding to maneuvers of a driver. The GNSS navigation device then determines which route segments of the plurality of route segments the user prefers based on the driving history. When generating a route, the GNSS navigation device then includes the preferred route segment.

### BACKGROUND OF THE INVENTION

1. Field of the Invention

The present invention relates to methods of performing routing in global navigation satellite systems, and more particularly, to a method of performing routing in a global navigation satellite system using artificial intelligence.

2. Description of the Prior Art

Global navigation satellite systems (GNSS), such as the Global Positioning System (GPS), Galileo, and GLONASS, provide navigation signals to personal navigation devices through their respective satellite constellations. Each satellite broadcasts the current time and its current location. Then, using this information, the personal navigation device may determine its current position based on its difference from at least three of the satellites, which is called trilateration. To determine the distance from each satellite to the personal navigation device, the personal navigation device compares the current time broadcast by each satellite with the respective times that the personal navigation device receives each of the signals. The longer a signal takes to reach the personal navigation device, the farther the personal navigation device is from the respective satellite.

The position of the personal navigation device as calculated from the signals broadcast by the various GNSS satellites may then be combined with a digital map, which contains coordinates for most or all roads in a given vicinity. Generally speaking, the digital map, or map database, will include a number of intersections (nodes). Each node may then be connected to an adjacent node by one or more paths, or route segments, each having an associated cost. The cost may be measured in travel time, travel distance, or some weighted blend of the two. Currently, routing algorithms use a cost-based method for calculating routes from an initial node to a destination node. An iterative process may be utilized to find a lowest cost route from the initial node to the destination node. The total cost of the route along the road network on the “virtual map” may be found by adding the costs associated with each maneuver on that route. User preferences for road types/journey type as described above are implemented by adjusting the costing for road types, etc., so if a user prefers motorways then the cost-per-mile of motorway will be lowered. In other words, each route segment connecting adjacent nodes may have a different type, and the type may be utilized to adjust cost for the route segment. Thus, the total cost for a route calculated with a high motorway content will be lower overall, and more likely to be presented as the route to the user.

However, it is common for the user to have a preferred route they have developed over time. For instance, the user may know a particular way to drive to work that avoids traffic spots, or requires fewer turns or traffic signals. In addition, the user may prefer different routes on weekdays and weekends. However, the prior art has no way, and does not, incorporate such information. Thus, the user will frequently deviate from the route provided by the personal navigation device, causing frequent rerouting and rendering the personal navigation device useless for most of the journey.

### SUMMARY OF THE INVENTION

According to a preferred embodiment of the present invention, a method of performing routing in a global navigation satellite system (GNSS) navigation device comprises the GNSS navigation device storing a driving history comprising a plurality of route segments corresponding to maneuvers of a driver, the GNSS navigation device determining a preferred route segment from the plurality of route segments according to the driving history, and the GNSS navigation device generating a route including the preferred route segment.

According to a second embodiment of the present invention, a method of performing routing in a global navigation satellite system (GNSS) navigation device comprises the GNSS navigation device storing a driving history comprising a plurality of route segments corresponding to maneuvers of a driver, the GNSS navigation device filtering the plurality of route segments according to a recurring time period, the GNSS navigation device determining a preferred route segment from the plurality of route segments after filtering, and the GNSS navigation device generating a route including the preferred route segment during an occurrence of the recurring time period.

According to a third embodiment of the present invention, a method of performing routing in a global navigation satellite system (GNSS) navigation device comprises the GNSS navigation device determining a first route from a first location to a destination location, the GNSS navigation device recording an alternate route when the GNSS navigation device detects a deviation from the first route, the GNSS navigation device determining a time period for traveling from the first location to the destination location along the alternate route, and the GNSS navigation device utilizing the alternate route instead of the first route based on a predetermined rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a preferred embodiment of a method of performing routing according to the present invention.

FIG. 2 is a diagram of a second embodiment of the method according to the present invention.

FIG. 3 is a diagram of a third embodiment of the method according to the present invention.

### DETAILED DESCRIPTION

Electronic or satellite-based navigation systems calculate a route from one point to another on a “virtual map”, and then provide guidance instructions to direct or navigate a user from a first location, e.g. the user's current location, to a second location, e.g. the user's desired destination location, using the “virtual map”. The route may be calculated using a set of predefined rules, such as user-defined preferences for shortest or quickest route, and user preference for road type, e.g. preference for motorways and A roads to B roads, and the “virtual maps” data, which may be stored in a map database, may include information such as road lengths and speed limits to allow route calculations based on the user preferences. The map database may include a plurality of nodes and a plurality of route segments. Each route segment may connect two adjacent nodes, and may correspond to a physical path, such as a road, a motorway, a bridge, etc.

Calculated routes may be affected by dynamic information, such as incoming traffic events, allowing the navigation system to divert the user around problems and therefore keeping their journey time to a minimum.

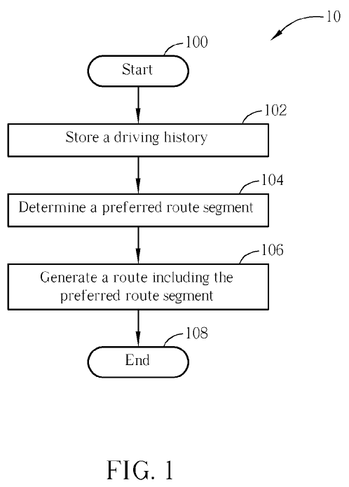

Please refer to FIG. 1, which is a diagram of a preferred embodiment of a method of performing routing according to the present invention. The method may be used in a global navigation satellite system (GNSS) navigation device, which may be used to receive positioning signals from GNSS satellites, such as GPS satellites, Galileo satellites, or GLONASS satellites. The GNSS navigation device may comprise a GNSS antenna for receiving GNSS positioning signals, a processor for processing the GNSS positioning signals, a memory for storing positioning data and mapping software, and a display for displaying a map, a position of the GNSS navigation device on the map, and a route from the position of the GNSS navigation device to a destination. Of course, other than the map, the GNSS navigation device may also display a graphical user interface for receiving inputs, such as an address of the destination. And, a user of the GNSS navigation device may also adjust the map displayed in the display, e.g. by panning or zooming the map. The method mentioned above is illustrated in the preferred embodiment by a procedure 10, which comprises the following steps:

Step 100: Start.

Step 102: Store a driving history.

Step 104: Determine a preferred route segment.

Step 106: Generate a route including the preferred route segment.

Step 108: End.

In the procedure 10 for performing routing in the global navigation satellite system (GNSS) navigation device, the GNSS navigation device may store a driving history comprising a plurality of route segments corresponding to maneuvers of a driver (Step 102). Then, based on the driving history, the GNSS navigation device may determine a preferred route segment of the plurality of route segments (Step 104). This may be accomplished by way of a neural networks algorithm, which may adjust a cost given to the preferred route segment according to a number of times in the driving history that the preferred route segment is utilized to navigate from the first location to the second location. The number of times may be summed over a predetermined period of time, such as one month. Further, the number of times may be limited to number of times the preferred route segment is chosen instead of a predetermined route segment. In other words, if the preferred route segment was originally included in a route calculated by the GNSS navigation device, i.e. if the preferred route segment is the predetermined route segment, the number of times may not be incremented when the preferred route segment is chosen. Finally, the GNSS navigation device may generate a route including the preferred route segment. Step 106 of the procedure 10 may be omitted or delayed in another embodiment. In other words, after determining the preferred route segment in Step 104, cost of the preferred route segment in the map database may be updated according to the number of times mentioned above. Then, at a later time, the route including the preferred route segment may be generated (Step 106). In another embodiment, once the preferred route segment has been determined (Step 104), the cost of the preferred route segment may be set to zero. In this way, the preferred route segment may contribute less cost to the overall route when determining the overall route, and may thereby be chosen by the GNSS navigation device when determining the shortest or quickest route using algorithms common to GNSS navigation devices. Finally, in addition to automatic updating of the cost of the preferred route segment, the cost may also be updated according to user input. For example, if the user designates a user-designated route segment as the preferred route segment, the cost of the user-designated route segment may be reduced or zeroed.

The GNSS navigation device may also compare a practical time for traveling from an initial location to a destination location along the route including the preferred route segment with a calculated time for traveling from the initial location to the destination location along a predetermined route not including the preferred route segment so as to generate a comparison result. Then, a cost assigned to the preferred route segment may be adjusted according to the comparison result. The cost assigned to the preferred route segment may be reduced if the practical time is less than the calculated time, or may be increased if the practical time is greater than the calculated time. In this way, the preferred route segment may contribute less cost to the overall route, and may thereby be chosen by the GNSS navigation device when determining the shortest or quickest route using algorithms common to GNSS navigation devices.

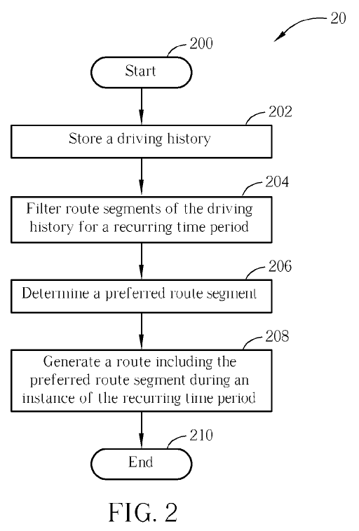

Please refer to FIG. 2, which is a diagram of a second embodiment of the method according to the present invention. The method may be used in the global navigation satellite system (GNSS) navigation device, which may be used to receive positioning signals from GNSS satellites, such as GPS satellites, Galileo satellites, or GLONASS satellites. The method is illustrated in the second embodiment by a procedure 20, which comprises the following steps:

Step 200: Start.

Step 202: Store a driving history.

Step 204: Filter route segments of the driving history for a recurring time period.

Step 206: Determine a preferred route segment.

Step 208: Generate a route including the preferred route segment during an instance of the recurring time period.

Step 210: End.

In the procedure 20 for performing routing in the global navigation satellite system (GNSS) navigation device, the GNSS navigation device may store a driving history comprising a plurality of route segments corresponding to maneuvers of a driver (Step 202). Then, the GNSS navigation device may filter the plurality of route segments according to a recurring time period (Step 204). The recurring time period may correspond to a same time period each day, each week, or each year. For example, the user may drive different routes during peak traffic periods, or on weekdays versus weekends, or even during particular holidays each year. Next, the GNSS navigation device may determine a preferred route segment of the plurality of route segments after filtering (Step 206). Finally, the GNSS navigation device may generate a route including the preferred route segment during an occurrence of the recurring time period. For example, during the peak traffic period each day, the GNSS navigation device may generate the route, including a route segment (the preferred route segment for the peak traffic period) that typically has less traffic. Or, on a weekend, the GNSS navigation device may generate the route, including a route segment that goes along a more scenic path, which the user prefers to take when free from schedule constraints.

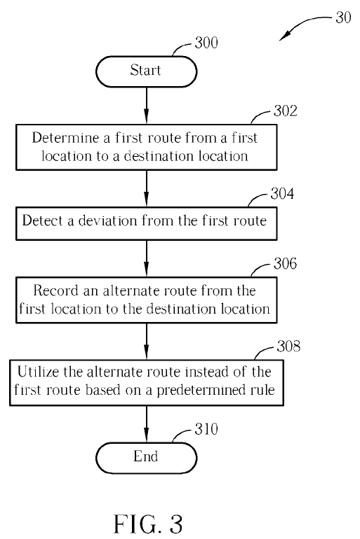

Please refer to FIG. 3, which is a diagram of a third embodiment of the method according to the present invention. The method may be used in the global navigation satellite system (GNSS) navigation device, which may be used to receive positioning signals from GNSS satellites, such as GPS satellites, Galileo satellites, or GLONASS satellites. The method is illustrated in the third embodiment by a procedure 30, which comprises the following steps:

Step 300: Start.

Step 302: Determine a first route from a first location to a second location.

Step 304: Detect a deviation from the first route.

Step 306: Record an alternate route from the first location to the second location.

Step 308: Utilize the alternate route instead of the first route based on a predetermined rule.

Step 310: End.

In the procedure 30 for performing routing in the global navigation satellite system (GNSS) navigation device, the GNSS navigation device may determine a first route from a first location to a destination location (Step 302). When determining the first route from the first location to the destination location, the GNSS navigation device may determine a shortest route from the first location to the destination location, or a fastest route from the first location to the destination location. Then, the GNSS navigation device may record an alternate route when the GNSS navigation device detects a deviation from the first route (Steps 304-306). The alternate route may be recorded according to the deviation. The GNSS navigation device may detect a deviation from the first route by detecting a maneuver that is different from a plurality of first maneuvers of the first route, or by detecting a position that is on a route segment not along the first route. The plurality of first route segments could be modified or replaced by a plurality of alternate route segments of the alternate route. As the user drives along the alternate route, the GNSS navigation device may determine a time period for traveling from the first location to the destination location along the alternate route. Finally, the GNSS navigation device may utilize the alternate route instead of the first route based on a predetermined rule (Step 308). The predetermined rule could be that the time period for traveling from the first location to the destination location along the alternate route is shorter than a calculated time period for traveling from the first location to the destination location along the first route. As described above for the embodiment in FIG. 1, Step 308 may be omitted or delayed in another embodiment, and the cost of the deviation may be reduced or zeroed according to number of times the deviation is recorded. Then, when generating a route from the first position to the second position after reducing or zeroing the deviation, the alternate route may be determined and utilized automatically.

The difference between method of calculating routes proposed in the present invention and the prior art method of calculating routes is that the new method may (i) learn the user's preferences, and (ii) learn road conditions, so as to (iii) provide the user with their own customized routing algorithms, which will differ from GNSS navigation device unit to GNSS navigation device unit based on the historical pattern of use of the GNSS navigation device. The system may use Neural Networks—a form of artificial intelligence—to adjust the routing algorithms. The method of implementation may use historical “learnt” information to adjust the weighting given to particular roads and road classes.

The system may evaluate the journey time along a particular road comparing the time taken to complete the journey in reality to that calculated using the default settings. If the actual journey time is shorter than the calculated journey time, then the weighting may be adjusted for those particular roads to make it more likely they will be used in routes in the future. If the actual journey time is longer than the calculated journey time then the weighting may be adjusted so that they are less likely to be used in the future.

If the user knows an alternative route which they prefer to that offered by the navigation system, the user may then ignore directions to take the offered route, instead opting for their own preferred route. In this scenario, the weighting of the user's preferred route may then be adjusted to make it more likely to be the offered route in the future.

The system may also analyze the time of day, day of week, and day of year. Typically, the system will learn the differences in traffic patterns during known holidays, weekdays, and weekends, and also the traffic patterns of the user during weekends and weekdays. This provides a more tailored navigation environment for the user.

Those skilled in the art will readily observe that numerous modifications and alterations of the device and method may be made while retaining the teachings of the invention.

What is claimed is:

1. A method of performing routing in a global navigation satellite system (GNSS) navigation device, the method comprising:
the GNSS navigation device storing a driving history comprising a plurality of route segments corresponding to maneuvers of a driver;
the GNSS navigation device determining a preferred route segment from the plurality of route segments according to the driving history; and
the GNSS navigation device generating a route including the preferred route segment.

2. The method of claim 1, wherein the GNSS navigation device determines the preferred route segment according to the driving history based on a neural networks algorithm.

3. The method of claim 2, wherein the neural networks algorithm adjusts a cost given to the preferred route segment according to a number of times in the driving history that the preferred route segment is utilized to navigate from a first location to a second location.

4. The method of claim 1, further comprising:
the GNSS navigation device comparing a practical time for traveling from a first location to a second location along the route including the preferred route segment with a calculated time for traveling from the first location to the second along a predetermined route not including the preferred route segment to generate a comparison result; and
adjusting a cost assigned to the preferred route segment according to the comparison result.

5. The method of claim 4, wherein the cost assigned to the preferred route segment is reduced if the practical time is less than the calculated time.

6. The method of claim 4, wherein the cost assigned to the preferred route segment is increased if the practical time is greater than the calculated time.

7. The method of claim 1, further comprising modifying cost of the preferred route segment according to number of times the preferred route segment was driven in the driving history.

8. A method of performing routing in a global navigation satellite system (GNSS) navigation device, the method comprising:
the GNSS navigation device storing a driving history comprising a plurality of route segments corresponding to maneuvers of a driver;
the GNSS navigation device filtering the plurality of route segments according to a recurring time period;
the GNSS navigation device determining a preferred route segment from the plurality of route segments after filtering; and
the GNSS navigation device generating a route including the preferred route segment during an occurrence of the recurring time period.

9. The method of claim 8, wherein the recurring time period corresponds to a same time period each day.

10. The method of claim 8, wherein the recurring time period corresponds to a same time period each week.

11. The method of claim 8, wherein the recurring time period corresponds to a same time period each year.

12. The method of claim 8, wherein the plurality of route segments and the preferred route segment correspond to physical roads.

13. The method of claim 8, wherein the GNSS navigation device is a GPS navigation device.

14. A method of performing routing in a global navigation satellite system (GNSS) navigation device, the method comprising:
the GNSS navigation device determining a first route from a first location to a second location;
the GNSS navigation device recording an alternate route when the GNSS navigation device detects a deviation from the first route;
the GNSS navigation device determining a time period for traveling from the first location to the second location along the alternate route; and
the GNSS navigation device utilizing the alternate route instead of the first route based on a predetermined rule.

15. The method of claim 14, wherein determining the first route from the first location to the second location comprises determining a shortest route from the first location to the second location.

16. The method of claim 14, wherein determining the first route from the first location to the second location comprises determining a fastest route from the first location to the second location.

17. The method of claim 14, wherein recording the alternate route comprises replacing a plurality of first route segments of the first route with a plurality of alternate route segments of the alternate route.

18. The method of claim 14, wherein recording the alternate route when the GNSS navigation device detects a deviation from the first route comprises the GNSS navigation device detecting a maneuver that is different from a plurality of first maneuvers of the first route.

19. The method of claim 14, wherein recording the alternate route when the GNSS navigation device detects a deviation from the first route comprises the GNSS navigation device detecting a position that is on a route segment not along the first route.

20. The method of claim 14, wherein the predetermined rule comprises the time period for traveling from the first location to the second location along the alternate route being shorter than a calculated time period for traveling from the first location to the second location along the first route.
